(19) United States
(12) Patent Application Publication
(10) Pub. No.: US 2006/0258783 A1
(43) Pub. Date: Nov. 16, 2006

(54) Moulded body containing plastic and reinforced by natural fibres

(76) Inventor: Markus Rettenbacher, PUCH (AT)

Correspondence Address: OSTROLENK FABER GERB & SOFFEN, 1180 AVENUE OF THE AMERICAS, NEW YORK, NY, 100368403, US

(21) Appl. No.: 10/493,718

(22) PCT Filed: Oct. 18, 2002
(86) PCT No.: PCT/EP02/11704

§ 371 Date: Jul. 13, 2004

(30) Foreign Application Priority Data
Oct. 23, 2001 (AT) A 1682/2001

(51) Int. Cl. C08L 5/00; D21H 19/54

(52) U.S. Cl. 524/27; 524/47

(57) ABSTRACT

The invention relates to a moulded body containing plastic and reinforced by natural fibres. Said moulded body is produced from fibrous plant or animal material containing residual water, at least one thermoplastic or duroplastic material, and at least one water-binding biopolymer and/or biomonomer, by means of plastic or thermoplastic deformation at a high temperature and/or high pressure, and then by shaping, preferably by means of extrusion. In spite of a residual water content of between 0.3 and 8 wt. %, the inventive moulded body is in an unexpanded form. The invention also relates to a method for producing said moulded body.

### FIELD OF THE INVENTION

The invention relates to an unexpanded moulded body containing plastic, reinforced by natural fibres and having a residual water content, and a process for its production.

### BACKGROUND OF THE INVENTION

In recent years, interest in natural fibre materials in the plastics industry has increased considerably. In particular, the use of wood fibres, woodmeal and wood chips in so-called “wood-like plastic” or “plastic timber” materials, which are processed with the aid of the extrusion technique to give profiles, has experienced a real boom.

Nevertheless, the problem that natural fibre materials, in particular wood, still contain a certain amount of residual water even in the air-dried state and hence the quality of profiles produced from plastic and wood parts is often unsatisfactory has not been satisfactorily solved to date. Particularly in the case of profiles which are produced at a high ejection velocity, uncontrollable bubbles and expansion zones occur, which are caused by the fact that, after plastic or thermoplastic forming of the raw material mixture, the residual water present evaporates very rapidly from the moulding material in the subsequent step for the final shaping of the moulding material to give the moulded body, as a result of the pressure relief, for example at the die exit of an extrusion unit. This even means that, at relatively high extrusion temperatures and extrusion velocities, the integrity of such a profile is no longer ensured.

Many of the processes which have been disclosed to date assume that the water content of the raw materials used has to be reduced as far as possible before the introduction into the actual and final extrusion step, in which the finished profile is produced. For this purpose, the natural materials are either usually prepared for use by excessive, conventional drying before the extrusion process, or an attempt is made to achieve evaporation of water between the two units by connecting two extrusion units in series. Thus, the first extrusion unit is actually used only as a dryer. The conventional materials obtained by such processes have a water content of about 0.2 to 0.5% by weight but are still expanded and have gas-filled cavities (small bubbles).

Processes in which the residual water is eliminated or consumed to a desired degree by chemical reactions by addition of a synthetic resin (JP 6123306) or of inorganic substances, such as CaO and CaSO₄ (JP 6143213, JP 52025844, JP 52025843, JP 57075851 and EP 913243) have also been proposed. In all these cases, however, the residual water still remaining will give, in the course of an extrusion process, moulded bodies which are expanded to a greater or lesser extent.

### SUMMARY OF THE INVENTION

It is the object of the invention, by using suitable additives, optionally in combination with a specifically tailored procedure, to ensure that the residual water present in the starting materials used according to the invention is at least partly bound and in any case the quality of the end product is not impaired by any bubble formation, uncontrolled expansion or burst bubbles.

The object is achieved by the embodiments characterized in the Patent Claims, according to which an economical, expansion-free and bubble-free, thermoplastic or thermosetting plastic moulded body filled with natural fibres and containing residual water is obtainable.

According to the invention, the moulded body consists of a material which is a mixture of particles of at least one residual water-containing, in particular plant or animal, fibre material with at least one thermoplastic or thermosetting plastic substance and a water-binding biopolymer and/or water-binding biomonomer.

In achieving the object, the invention starts from the basic concept that, with the use of natural fibre materials, in particular of wood, for the production of profiles with the aid of plastic or thermoplastic forming methods, for example by means of extrusion, even in the case of the most careful and most elaborate preliminary drying of the raw materials used, water (residual water) is still introduced into the production process and therefore inevitably spontaneously evaporates on abrupt pressure relief and foams and expands the extruded material.

A suitable substance, in particular a substance having high affinity to natural fibres, was therefore sought, which substance is capable of binding this water during the production process so that it is not available for evaporation during the final shaping of the moulding material to give the finished moulded body. Ideally, however, this water should not be completely consumed or irreversibly bound by chemical reaction but should at least partly still be available after the final shaping, in order to minimize further water absorption of the finished moulded body, e.g. profile, due to the ambient humidity at the place of use, and the associated dimensional changes. This would save time-consuming and expensive conditioning of the finished profiles.

Surprisingly, it was found that, by the addition of at least one biopolymer and/or biomonomer, the desired water binding can be achieved under certain preconditions and hence particularly accurately shaped and dimensionally accurate moulded bodies can be produced, even at relatively high extrusion velocities, but the bound water is nevertheless effective for achieving a certain relative humidity in the finished profile.

According to the invention, compact, unexpanded moulded bodies having a water content of not more than 8% by weight, preferably of 0.3 to 6% by weight and in particular of 1 to 5% by weight, based on its total mass, can be produced if the residual water content of the raw material mixture at the start of the production process is also within the range of 0.3 to 8% by weight or if it is ensured by process engineering measures that the residual water content of the raw material mixture is reduced, in the course of the plastic or thermoplastic forming to give the moulding material, to the water contents mentioned.

Thus, for example, the original residual water content of the raw material mixture can, if required, be reduced to the values permitted according to the invention during the plastic or thermoplastic forming by addition of further water-binding or water-consuming substances and/or by pressure relief and devolatilization in the process unit. What is important is that the moulding material obtained from the plastic or thermoplastic forming has a water content of not more than 8% by weight immediately before its final shaping to give the moulded body. If this limit is exceeded, the proportion of biopolymer and/or biomonomer in the moulding material can no longer completely prevent water vapour formation taking place inside the moulding material in the course of the pressure relief and hence expansion of the moulded body.

As a result of these measures, moulded bodies are obtained whose matrices have no or at most insignificant proportions of gas-filled cavities (small bubbles) or expansion zones. Depending on the choice of the fibre material used, the moulded bodies according to the invention have a density of 0.5 to 2 g/cm³, in particular of 1.2 to 1.5 g/cm³.

In the context of the present invention, an “unexpanded” or “expansion-free” moulded body is to be understood as meaning a moulded body which experiences a volume growth of less than 10% in the course of the production process as a result of the final shaping step, i.e. has an expansion index of less than 1.1, in particular of 1.00 to 1.09 and preferably an expansion index of 1.00 to 1.05.

### DETAILED DESCRIPTION OF THE INVENTION

According to the invention, biopolymers and/or biomonomers are added as “water-binding” natural substances. Any biopolymers which interact with water at elevated temperature and incorporate or enclose it are suitable for this purpose. They may change their tertiary structure and thus even develop thermoplastic properties, as is the case in particular with starch. Moreover, such biopolymers, such as, for example, starch, improve the mechanical properties of the moulded body. In addition to isolated starch, comminuted crops, such as maize or rice, in the form of flour can also be added as sources of starch. Further suitable water-binding biopolymers which can be obtained from renewable raw material are proteins (e.g. gluten, collagen, keratin), lignins, pectins and hemicelluloses, which combine water similarly to starch. For the moulded bodies according to the invention, modified biopolymers are also suitable, but unmodified, natural biopolymers are preferably used. Biopolymers which are produced synthetically, for example in fermentation processes, are also suitable, provided that they contain monomers which are the same as or similar to the natural biopolymers and have the corresponding water binding capability.

“Water-binding” biomonomers are to be understood as meaning sugar or sugar-like, monomeric to oligomeric substances, by the use of which the boiling point of the residual water of the moulding material is increased beyond the melt temperature, with the result that the residual water does not evaporate in the course of the pressure relief during the final shaping, for example at the die exit of an extrusion unit. Suitable biomonomers are, for example, monosaccharides, in particular glucose and fructose, and disaccharides, in particular sucrose, lactose and maltose, and furthermore dextrins, but also sugar alcohols, such as glycerol, sorbitol, mannitol or xylitol.

At least one biopolymer and/or at least one biomonomer in an amount of 1 to 50% by weight, preferably 5 to 40% by weight, is added to the raw material mixture, these values always being based on the mixture in the case of a mixture of different biopolymers or biomonomers or a mixture of biopolymer and biomonomer.

Moreover, further substances which can additionally either physically or chemically bind excess water during the plastic or thermoplastic forming can be added to the raw material mixture. Physical binding of water is understood as meaning that substances which incorporate the existing water as the water of crystallization, as is the case, for example, with calcined gypsum, are used as additives, or salts which have colligative properties with respect to water and lead to a boiling point elevation are used. Chemical binding of water is understood as meaning, for example, the use of calcium oxide, which is converted into calcium hydroxide in the presence of water and thus directly “consumes” water so that it is no longer available for evaporation. These substances include, for example, calcium chloride, potassium carbonate, magnesium oxide, magnesium sulphate, potassium hydroxide, anhydrite, silica gel, sodium-potassium alloys, alumina, oxalic acid, potassium acetate, lithium chloride and ammonium chloride. These additives are preferably added in an amount of 1 to 15% by weight, based on the raw material mixture.

Optionally, further auxiliaries customary in plastics technology, such as plasticizers, adhesion promoters, colorants, lubricants, stabilizers or antioxidants, can be added to the raw material mixture in an amount of, preferably, 0.2 to 10% by weight, in particular of 0.5 to 8% by weight, based on the total mass of the raw material mixture.

Thermoplastic or thermosetting plastic substances which are suitable as a matrix for the material of the moulded body are those plastics which can be extruded, pelleted, pressed, pultruded or injection moulded. Here, the term “matrix” represents that part of the moulding material which is intended to ensure the cohesion of the natural fibres to form a certain shaped article. Suitable thermoplastic or thermosetting plastic substances are all plastics which are used in the area of “wood-like plastics” or “plastic timbers”. In addition to the most important plastics for wood extrusion, such as polypropylene, polyethylene or PVC, in particular melamine should be mentioned here, which has high affinity to wood and is very abrasion-resistant, ecologically safe and variable with regard to its thermoplastic properties. The raw material mixture may contain 5 to 50% by weight, but preferably 10 to 35% by weight, of plastics.

In principle, all materials of plant or animal origin which contain fibrous polymers and can thus impart good strength properties to the moulded bodies can be used as water-containing fibre materials. Examples of suitable plant fibre materials are wood fibres, woodmeal or wood chips, predominantly cellulose-containing materials, such as straw, waste paper, hemp or flax. However, animal fibre materials, for example in the form of leather wastes, may also be used. In particular, the tensile strength of the moulded bodies according to the invention is increased by the fibres. The natural fibre materials containing residual water are contained in the raw material mixture in an amount of 5 to 85% by weight. The fact that the fibre material need not be completely dry in the process according to the invention considerably reduces the total energy consumption for the process.

On the basis of their structure, the natural fibre materials used may be porous. In particular, wood, two thirds of which consists of cavities, retains this structure through the processing process according to the invention and can thus contribute towards a reduction in the density of the moulded bodies and the associated cost saving.

The plastic or thermoplastic forming techniques are the preferred methods in the plastics-processing industry. The present invention can, however, be applied to all known forming methods, for example pultrusion.

“Wood-like plastic” or “plastic timber” products, which also include the moulded bodies according to the invention, are predominantly produced by profile extrusion or by injection moulding.

Granules can be produced beforehand with the various raw materials by extrusion, pelleting or hot mixing and are then processed in a profile extruder or an injection moulding machine to give finished shaped articles.

For the production of the moulded bodies, the particles of the plant or animal fibre material containing residual water are mixed with at least one thermoplastic or a thermosetting plastic substance from the group consisting of the plastics and at least one biopolymer and/or at least one biomonomer. This raw material mixture is then formed into a plastic moulding material at a temperature at least above room temperature, preferably at 100 to 300° C., particularly preferably at 130 to 210° C., and/or at a superatmospheric pressure of up to 500 bar, preferably at a pressure of 10 to 300 bar, in particular of 50 to 200 bar. The plastic moulding material is then brought into the desired shape of the moulded body, which is obtained after cooling and solidification of the melt. In order to prevent damage and thermodegradation of the biopolymer or biomonomer, temperatures of not more than 210° C. are preferably employed.

In recent years, a method which produces finished profiles starting directly from the pulverulent raw materials in one preparation has also become established. This method is described, for example, in WO 90/14935.

According to the invention, the incompletely dry plant fibre material, for example woodmeal, plastic granules, biopolymer and/or biomonomer, and optionally the additives are metered, with or without prior mixing, directly into the feed orifice of an extruder. In this method, the problem of the residual water is most pronounced due to natural fibres used, in particular in the case of wood materials. In this so-called “direct production”, the method according to the invention, in which the residual water is bound by the biopolymers and/or biomonomers, has therefore proved particularly preferably good.

By heating and/or by pressure relief of the material inside the process unit, for example an extruder screw, any excess water content of the material can be reduced by evaporation. The water vapour is preferably removed through so-called devolatilization orifices in the housing of the process unit.

If evaporatable water is present in the moulding material and, for example, an extruder is operated at 120 to 200 degrees Celsius melt temperature and at about 100 bar at the profile die exit, this water is evaporated abruptly—without the measures according to the invention—when the pressure drops to atmospheric pressure, and a foamed, expanded product having gas-filled cavities and small bubbles forms, as is the case, for example, in the method of WO 90/14935. This effect, which is undesired here, is eliminated by the present invention and a compact, unexpanded moulded body is produced, which has a water content of 0.3 to 8% by weight, based on its total mass directly after its production, i.e. after solidification of the moulding material obtained under elevated pressure and/or elevated temperature by plastic or thermoplastic forming of a raw material mixture and subjected to subsequent final shaping. It is a further characteristic of the present invention that the water content of the finally—shaped product substantially corresponds to the water content of the moulding material directly before the final shaping step. “Substantially” means that there is no water loss through evaporation from the interior of the moulding material, but at most evaporation of superficially adhering moisture, as a result of the step for the final shaping of the moulding material to give the moulded body, for example on passage of the moulded material through the extruder die and subsequent pressure relief, but this has no adverse effects on the present invention.

Depending on the applications of the moulded bodies, the properties, such as UV stability, tensile and compressive strength, colour, water resistance, etc., are controllable within a substantially variable range.

There are scarcely any limits to the use of the moulded bodies according to the invention. Thus, storable granules which are either expansion-free or have been expanded by the method of WO 90/14935 can first be produced, for example by extrusion and, in further operations, said granules can be melted by the method of the present invention and can be processed to give profiles, injection moulded and die cast articles or the like. The profiles or injection moulded articles can be used both in the interior and the exterior area, wherever plastic or wood parts are used today. Examples of such moulded bodies are square sections, strips, facade parts, floorboards, fence elements, cable ducts, panels, profiles, claddings, packaging materials, hollow profiles, trims or docking means.

The method according to the invention is described in more detail below with reference to examples.

### COMPARATIVE EXAMPLE 1

80 kg of wood chips having an average size of 1 mm (water content of the wood chips 10% by weight), 18 kg of polypropylene and 2% by weight of adhesion promoter were metered gravimetrically per hour into a conical twin-screw extruder having devolatilization orifices (from Cincinnati Extrusion). The devolatilization orifices of the extruder were closed. The moulded body produced was a skirting board.

Extrusion conditions:

Temperature of feed zone: 150° C.

Temperature of zone 1: 160° C.

Temperature of zone 2: 200° C.

Temperature of zone 3: 200° C.

Temperature of zone 4: 190° C.

Temperature of die inflow: 190° C.

Die temperature: 190° C.

Directly flange-connected sizing unit: 50° C.

Screw temperature: 190° C.

Screw speed: 35 rpm

Melt temperature: 190° C.

Exit speed of the board from the die: 5.5 m/min

The skirting board thus produced had unacceptable expansions and bubbles. The water evaporating at the end of the die or end of the sizing unit prevented production true to shape. The evaporation of water was so great that cohesion of the profile was not ensured.

### COMPARATIVE EXAMPLE 2

The raw material mixture metered in in Example 1 and comprising altogether 100 kg/h was reduced to 20 kg/h under the same extrusion conditions. All other conditions were retained. The exit speed of the board from the die was about 1 m/min.

It was possible to produce at least one cohesive profile, but uncontrolled expansions and bubbles still occurred to a very great extent.

### COMPARATIVE EXAMPLE 3

The procedure was as in example 2. The only modification compared with example 2 was the use of wood, which was dried to a water content of about 5% by weight prior to the extrusion. The die exit speed of the board was about 1 m/min.

It was possible to produce a cohesive profile, which however still had some expansion points and bubbles.

### EXAMPLE 4

Compared with Example 3, fine maize flour (comminuted maize kernels having a starch content of 70% by weight) was added to the formulation. This then gives the following composition:

71% by weight of wood chips

15% by weight of polypropylene

12% by weight of maize flour (water content 11% by weight)

2% by weight of adhesion promoter

The extrusion conditions corresponded to those of Example 3, with a raw material metering rate of 20 kg/h into the extruder and an exit speed of the profile at the end of the die of about 1 m/min.

With this formulation and the conditions described above, it was possible to produce attractive skirting boards which were true to shape.

### EXAMPLE 5

The procedure was as in Example 4. The only modification compared with Example 4 was primarily the increase of the metering rate of the raw material mixture to 80 kg/h. This resulted in a profile exit speed of about 4 m/min. Up to this speed, it was possible to produce a satisfactory, bubble-free profile.

The metering rate of the raw material mixture was then increased to 100 kg/h. This gave a profile exit speed of about 5.5 m/min.

The first expansion points (bubbles) were found in the finished profile. By opening the devolatilization orifices in the first third of the extrusion barrel and metering in 5% by weight of magnesium oxide into the raw material mixture used, it was possible to produce a satisfactory profile true to shape.

### EXAMPLE 6

With the aid of a single-screw extruder, granules which had the following composition were produced:

67% by weight of wood (residual water content about 11% by weight)

15% by weight of maize flour (residual water content about 11% by weight)

15% by weight of polypropylene

2% by weight of adhesion promoter

1% by weight of titanium oxide

The finished granules produced from the above raw material mixture (residual water content about 9% by weight) had a water content of 5% by weight immediately after the extrusion and exhibited slight expansion—analogous to WO 90/14935. The bulk density was 500 kg/m³.

These granules, which were not further dried, were extruded in a conical twin-screw extruder to give a profile. 100 kg of expanded granules per hour were metered into the extruder. The devolatilization orifices of the extruder were closed.

Extrusion conditions:

Temperature of feed zone: 150° C.

Temperature of zone 1: 155° C.

Temperature of zone 2: 160° C.

Temperature of zone 3: 165° C.

Temperature of zone 4: 170° C.

Temperature of die inflow: 170° C.

Die temperature: 170° C.

Directly flange-connected sizing unit: 40° C.

Screw temperature: 165° C.

Screw speed: 35 rpm

Melt temperature: 165° C.

Exit speed of the board from the die: 5.5 m/min

Although the melt temperature was 165° C., it was possible to produce an expansion-free (expansion index <1.05) and dimensionally accurate profile even at a profile extrusion speed of about 5.5 m/min. The water content of the profile corresponded to the water content of the granules used.

This example makes it clear that an expanded moulded body was obtained in the first process part (not according to the invention) when the raw material mixture had a residual water content of about 9% by weight, whereas a substantially expansion-free moulded body was obtained in the second process part (according to the invention) under comparative conditions and with the same moulding material, but at a residual water content reduced to 5% by weight.

The advantage of the profiles thus produced is that the residual water contents of the finished profiles correspond approximately to the conditions of average ambient humidity immediately on emerging from the water cooling zone, and the profiles no longer have to be conditioned by an expensive procedure before they are used in practice. Dimensional stability exists immediately after the profile extrusion.

### EXAMPLE 7

The procedure was as in Example 3. In addition to the raw materials described there, sucrose was used in the formulation. This resulted in the following raw material mixture:

70% by weight of wood chips (residual water content 5% by weight)

18% by weight of polypropylene

10% by weight of sucrose

2% by weight of adhesion promoter

It was possible to produce an attractive profile which had no expansion points.

1. Moulded body consisting essentially of a moulding material obtained after plastic or thermoplastic forming of a residual water-containing raw material mixture and solidified after a final shaping step and containing particles of at least one plant or animal fibre material together with at least one thermoplastic or thermosetting plastic and at least one material selected from the groups consisting of water-binding biopolymers and water-binding biomonomers, characterized in that it has a water content of not more than 8% by weight and has not been expanded.

2. Moulded body according to claim 1, having a density of 0.5 to 2 g/cm³.

3. Moulded body according to claim 1, the water-binding biopolymer being selected from the group consisting of the starches, pectins, lignins, proteins and hemicelluloses.

4. Moulded body according to claim 1, the biomonomer being selected from the group consisting of the monosaccharides, disaccharides, dextrins and sugar alcohols.

5. Moulded body according to claim 1, the raw material mixture additionally containing a water-binding or water-consuming substance selected from the group consisting of calcium chloride, calcium oxide, potassium carbonate, magnesium oxide, magnesium sulphate, potassium hydroxide, phosphorus pentoxide, molecular sieves, calcium sulphate, anhydrite, calcined gypsum, silica gel, sodium-potassium alloys, alumina, oxalic acid, potassium acetate, lithium chloride and ammonium chloride.

6. Moulded body according to claim 5, the additional water-binding or water-consuming substance being present in an amount of 1 to 15% by weight, based on the total mass of the raw material mixture.

7. Moulded body according to claim 1, the thermoplastic or thermosetting plastic being selected from the group consisting of polyethylene, polypropylene, PVC, polymethacrylate, polystyrene, urea resin and melamine.

8. Moulded body according to claim 1, the plant fibre material being selected from the group consisting of wood fibres, woodmeal, wood chips, cellulose-containing recycled materials, wastepaper, hemp and leather wastes.

9. Moulded body according to claim 1, which contains 5 to 50% by weight of thermoplastic or thermosetting plastic substance, 1 to 50% by weight of biopolymer or biomonomer or of a mixture of biopolymer and biomonomer and 5 to 85% by weight of plant fibre material.

10. Moulded body according to claim 1, which contains further additives selected from the group consisting of adhesion promoters, colorants, lubricants, stabilizers and antioxidants.

11. Moulded body according to claim 10, the further additives being contained in an amount of 0.2 to 10% by weight, based on its total mass.

12. Moulded body according to claim 1, which is moulded so as to form of granular particles.

13. Moulded body according to claim 1, which is moulded so as to form a product selected from the group consisting of square section, strip, facade part, floorboard, fence element, cable duct, panel, profile, cladding, packaging material, trim and docking means.

14. Moulded body according to claim 1, which is thermosetting or thermoplastic.

15. Method for the production of a moulded body consisting essentially of a moulding material obtained after plastic or thermoplastic forming of a residual water-containing raw material mixture and solidified after a final shaping step and containing particles of at least one plant or animal fibre material together with at least one thermoplastic or thermosetting plastic and at least one material selected from the groups consisting of water-binding biopolymers and water-binding biomonomers and having a water content of not more than 8% by weight and not being expanded, said method comprising the steps of:
mixing particles of a plant or animal fibre material which has a residual water content of 0.5 to 15% by weight, with at least one thermoplastic or thermosetting plastic and with at least one material selected from the group consisting of water-binding biopolymers and water-binding biomonomers to give a raw material mixture, and
forming the raw material mixture by a plastic or thermoplastic method with a temperature increase, a pressure increase, or both, to give a moulding material, after which
the moulding material is subjected to final shaping, and
an expansion-free, residual water-containing moulded body is obtained thereby.

16. Method according to claim 15, the plastic or thermoplastic forming being effected by extrusion, pultrusion, hot mixing, pressing, pelleting or injection moulding.

17. Method according to claim 15, the plastic or thermoplastic forming being effected in an apparatus which is equipped with devolatilization orifices and, during the forming, the water content of the raw material mixture or of the moulding material being reduced by partial pressure relief and removal of liberated water vapour through the devolatilization orifices.

18. Method according to claim 15, the plastic or thermoplastic forming being effected at a temperature of 100 to 300° C., and at a pressure of 1 to 500 bar.

19. Method according to claim 15, the biopolymer being selected from the group consisting of the starches, pectins, lignins, proteins and hemicelluloses.

20. Method according to claim 15, the biomonomer being selected from the group consisting of the monosaccharides, disaccharides, dextrins and sugar alcohols.

21. Method according to claim 15, wherein a water-binding or water-consuming substance selected from the group consisting of calcium chloride, calcium oxide, potassium carbonate, magnesium oxide, magnesium sulphate, potassium hydroxide, phosphorus pentoxide, molecular sieves, calcium sulphate, anhydrite, calcined gypsum, silica gel, sodium-potassium alloys, alumina, oxalic acid, potassium acetate, lithium chloride and ammonium chloride is also b added to the raw material mixture.

22. Method according to claim 21, the additional water-binding or water-consuming substance being used in an amount of 1 to 15% by weight, based on the total mass of the raw material mixture.

23. Method according to claim 15, the thermoplastic or thermosetting plastic being selected from the group consisting of polyethylene, polypropylene, PVC, polymethacrylate, polystyrene, urea resin and melamine.

24. Moulded body according to claim 1, having a water content of 0.3% to 6% by weight.

25. Moulded body according to claim 24, having a water content of 1% to 5% by weight.

26. Moulded body according to claim 2, having a density of 1.2 to 1.5 g/cm³.

27. Method according to claim 15, wherein said fibre material has a residual water content of 5% to 11% by weight.

28. Method according to claim 18, wherein said forming temperature is 130 to 210° C.

29. Method according to claim 18, wherein said forming pressure is 50 to 200 bar.
